(19) United States
(12) Patent Application Publication
(10) Pub. No.: US 2010/0305346 A1
(43) Pub. Date: Dec. 2, 2010

(54) METHOD FOR PRODUCING FATTY ACID MONOESTERIFIED PRODUCT USING SOLID ACID CATALYST

(75) Inventors: Michikazu Hara, Yokohama-shi (JP); Kunihiko Yamashita, Tokyo (JP)

Correspondence Address: BIRCH STEWART KOLASCH & BIRCH, PO BOX 747, FALLS CHURCH, VA, 22040-0747, US

(73) Assignees: Tokyo Institute of Technology, Tokyo (JP); ASAHI KASEI KABUSHIKI KAISHA, Osaka-shi ,Osaka (JP)

(21) Appl. No.: 12/741,347

(22) PCT Filed: Oct. 27, 2008
(86) PCT No.: PCT/JP2008/069456

§ 371 Date: Aug. 2, 2010

(30) Foreign Application Priority Data
Nov. 5, 2007 (JP) 2007-286875
Nov. 5, 2007 (JP) 2007-286876

(51) Int. Cl. C11C 1/06

(52) U.S. Cl. 554/170; 554/124

(57) ABSTRACT

The present invention provides a method for producing a fatty acid monoester product by reacting an animal oil and/or a vegetable oil with an alcohol in the presence of a sulfonic acid group-introduced amorphous carbon catalyst and water. By this method, the production of a fatty acid monoglyceride, which is difficult to separate from the fatty acid monoester, can be suppressed, and the fatty acid monoester can be efficiently produced.

Also, the present invention provides a method for producing a fatty acid monoester product by performing the transesterification reaction of an animal oil and/or a vegetable oil with an alcohol, or the esterification reaction of a fatty acid with an alcohol, in the presence of a sulfonic acid group-introduced amorphous carbon catalyst washed with water. By this method, the life of the catalyst can be extended, and the production cost can be reduced.

### TECHNICAL FIELD

The present invention relates to a method for producing a fatty acid monoester product by reacting an animal oil and/or a vegetable oil with an alcohol in the presence of a sulfonic acid group-introduced amorphous carbon catalyst, which is a solid acid catalyst, and water.

Also, the present invention relates to a method for producing a fatty acid monoester product by performing the transesterification reaction of an animal oil and/or a vegetable oil with an alcohol, or the esterification reaction of a fatty acid with an alcohol, in the presence of a sulfonic acid group-introduced amorphous carbon catalyst washed with water.

### BACKGROUND ART

Conventionally, attempts have been made to produce a fatty acid monoester product using a vegetable oil or an animal oil as a raw material and use the fatty acid monoester product as a diesel fuel. The vegetable oil or the animal oil has a low sulfur content, and therefore, when it is used as a diesel fuel, little sulfur oxides (SO_{X}) are produced. Also, carbon dioxide produced by combusting a fuel comprising an oil and fat derived from a vegetable is fixed again during the growth of a crop, and therefore, this fuel is considered as a zero CO₂ emission fuel and regarded as a promising contributor to environmental conservation.

Such a diesel fuel is produced using an aliphatic triglyceride, the main component of a vegetable oil or an animal oil, as a raw material, by (1) a method for transesterifying a vegetable oil or an animal oil in an alcohol solvent, using an alkali as a catalyst, to produce the corresponding fatty acid monoester, (2) a method for producing a fatty acid monoester by using no catalyst and adding water to a vegetable oil or an animal oil to hydrolyze the vegetable oil or the animal oil under supercritical or subcritical conditions, and then adding an alcohol to the obtained hydrolysate to esterify the hydrolysate under supercritical or subcritical conditions, further (3) a method for producing a fatty acid monoester by adding an alcohol to a vegetable oil or an animal oil to transesterify the vegetable oil or the animal oil under supercritical or subcritical conditions, and the like.

However, a vegetable oil or an animal oil generally comprises a free fatty acid, and therefore, in the above (1) method for producing a fatty acid monoester by adding an alkali catalyst, a free fatty acid reacts with the alkali catalyst before the transesterification reaction to produce soap and water. The water significantly decreases the catalytic action of the alkali, and the produced soap act as a surfactant, thus making the separation of the product and the catalyst difficult.

On the other hand, as the above (2) and (3) methods of transesterification and esterification under supercritical or subcritical conditions, there is a method for producing a fatty acid ester from an oil and fat and an alcohol, comprising reacting the oil and fat with the alcohol without adding a catalyst under conditions in which the oil and fat and/or the alcohol is in a supercritical state (Patent Document 1). In Example 1 in Patent Document 1, waste soybean oil is reacted with methanol at a temperature of 300° C. at a pressure of 6.5 MPa to obtain a fatty acid methyl ester. There is also a method for similarly treating an animal oil or a vegetable oil in the absence of a catalyst, using a supercritical or subcritical alcohol as a solvent, to selectively obtain a fatty acid monoester product corresponding to the alcohol used as the solvent in a short time (Patent Document 2). In Example 1 in Patent Document 2, used rapeseed oil is reacted with methanol at a temperature of 240 to 360° C. at a pressure of 40 MPa to obtain a monoester product.

In addition, as a method for producing a fatty acid monoester from a fatty acid ester, there is a method for producing a fatty acid monoester by a transesterification reaction using a solid catalyst. This method is a method using a catalyst comprising a metal oxide as a solid catalyst, wherein a composite inorganic oxide catalyst comprising amorphous zirconium oxide (A), and an oxide of a group III element, an oxide of a group V element, and/or an oxide of a group IV element, other than zirconium and hafnium, (B) is used, and this composite inorganic oxide catalyst is contacted with a raw material ester and an alcohol for transesterification to produce an ester product (Patent Document 3). It is described that by using the above catalysts (A) and (B) in combination, the reaction can proceed at a pressure substantially equal to an ordinary pressure. In Examples in Patent Document 3, transesterification is performed by a reaction at a reaction temperature of 200 to 250° C., using a catalyst obtained by mixing ZrO₂ with TiO₂ or SiO₂, or a catalyst obtained by mixing ZrO₂ with ZnAl₂O₄ having a spinel structure, xZnO, or yAl₂O₃ (x and y=0 to 2), as the composite inorganic oxide catalyst.

On the other hand, there are also disclosed a method for producing ethyl acetate from acetic acid and ethyl alcohol, using a sulfonic acid group-introduced amorphous carbon catalyst as a solid catalyst (Patent Document 4), and a method for producing a higher fatty acid ester from a higher fatty acid and a lower alcohol (Patent Document 5). In Examples in Patent Document 4, concentrated sulfuric acid is added to naphthalene, coronene, heavy oil, and the like, they are heated at 250° C. for 15 hours, and the excess concentrated sulfuric acid is removed by reduced-pressure distillation to obtain a black powder. The black powder is allowed to act on acetic acid and ethyl alcohol to see the effect of a catalyst. In Example 1 in Patent Document 5, ethyl oleate is obtained from ethanol and oleic acid using a sulfonic acid group-introduced amorphous carbon catalyst.
Patent Document 1: Japanese Patent Laid-Open No. 2000-143586
Patent Document 2: Japanese Patent Laid-Open No. 2000-204392
Patent Document 3: International Publication No. WO 2005/000782
Patent Document 4: International Publication No. WO 2005/029508
Patent Document 5: International Publication No. WO 2007/000913

### DISCLOSURE OF THE INVENTION

### Problems to be Solved by the Invention

However, in the methods described in the above Patent Document 1 and Patent Document 2, an oil and fat comprising a triglyceride and the like as the main component are reacted with an alcohol, but transesterification occurs under supercritical conditions as reaction conditions. In terms of simplifying the apparatus, ensuring safety, and the like, the development of a method that can produce a fatty acid monoester product under milder conditions is desired. Also, the fatty acid monoester product fraction obtained by the method described in the above Patent Document 2 does not satisfy the standard of the acid value of a biodiesel fuel determined by the European and American standards and may have an acid value of more than 0.5. In a transesterification reaction, a triglyceride included in an animal oil and the like reacts directly with an alcohol to produce a fatty acid monoester. But, if water is simultaneously present, the triglyceride is hydrolyzed to become a fatty acid, and the esterification of the fatty acid further produces water as a by-product. Therefore, the reaction equilibrium in which the fatty acid monoester is produced from the fatty acid and the alcohol transitions to the reverse reaction side due to the presence of the water. This tendency increases as the temperature increases, particularly under supercritical conditions and the like. In order to decrease the acid value, an important factor is to sufficiently decrease the moisture in the reaction liquid. But, when oils and fats comprising fatty acids are used as raw materials, water is produced as a by-product, and therefore, it is very difficult to achieve an acid value of 0.5 or less. The same applies to a case where the raw material comprises moisture.

On the other hand, cause substances that can increase the acid value, such as a free fatty acid, moisture, and the like included in the raw material, should be removed. But, it is not easy to remove the free fatty acid from a large amount of the animal oil or the vegetable oil, the raw material oil, and such pretreatment is a cause of decreasing the yield of the product from the oils and fats.

Also, the transesterification reaction of the triglyceride with the alcohol produces the triglyceride as well as a diglyceride and a monoglyceride as by-products. But, the monoglyceride has a boiling point close to that of the fatty acid monoester, and therefore, the separation of the monoglyceride is difficult, and compounds, such as the monoglyceride having a glycerin skeleton, are mixed into the fatty acid monoester product. When the fatty acid monoester product is used as a biodiesel fuel, it may not satisfy product specifications that the total glycerin equivalent amount is 0.24% by mass or less, provided that the percentage by mass of the amount of glycerin included in the fatty acid monoester product, and glycerin constituting the triglyceride, the diglyceride, and the monoglyceride, with respect to the total mass of the fatty acid monoester product, is defined as “the total glycerin equivalent amount,” as shown in the following formula:

Gₜₒₜₐₗ(% by mass)=0.2591 W_{MG}+0.1488 W_{DG}+0.1044 W_{TG}+W_{G} [Expression 1]

wherein Gₜₒₜₐₗ represents the total glycerin equivalent amount; W_{MG} represents the % by mass of the monoglyceride in the fatty acid monoester product; W_{DG} represents the % by mass of the diglyceride in the fatty acid monoester product; W_{TG} represents the % by mass of the triglyceride in the fatty acid monoester product; and W_{G} represents the % by mass of glycerin in the fatty acid monoester product.

Also, the above Patent Document 3 describes a method using a catalyst comprising a metal oxide as a solid catalyst as a catalyst that can produce a fatty acid monoester. But, the reaction temperature is as high as 200 to 250° C., and the reaction occurs under conditions close to supercritical temperature conditions. A reaction under further milder conditions is desired.

In Patent Documents 4 and 5, a sulfonic acid group-introduced amorphous carbon catalyst is used, but its reaction occurs under conditions in which no water is added. Also, the sulfonic acid group-introduced amorphous carbon catalyst used in the reaction is a catalyst that has never been used before for an esterification reaction and a transesterification reaction.

The present invention has been made under such circumstances. It is an object of the present invention to provide means for efficiently producing a fatty acid ester product.

### Means for Solving the Problems

The present inventor has diligently studied over and over to solve the above problems, and, as a result, has found that (1) by containing water in a reaction system in reacting an animal oil or a vegetable oil with an alcohol in the presence of a sulfonic acid group-introduced amorphous carbon catalyst to produce a fatty acid monoester, the production of a monoglyceride produced as a by-product can be suppressed, and that (2) when the sulfonic acid group-introduced amorphous carbon catalyst is used for an esterification reaction or a transesterification reaction, the catalytic activity decreases gradually, and the catalytic activity can be recovered by water washing, thus leading to the completion of the present invention.

Specifically, the present invention provides the following (1) to (10).
(1) A method for producing a fatty acid monoester product, comprising a first step of reacting an animal oil and/or a vegetable oil with an alcohol in the presence of a sulfonic acid group-introduced amorphous carbon catalyst and water to obtain a fatty acid monoester product reaction liquid.
(2) The method for producing a fatty acid monoester product according to (1), comprising a second step of removing glycerin, the alcohol, and water from the fatty acid monoester product reaction liquid to obtain a fatty acid monoester fraction, and a third step of contacting and reacting the fatty acid monoester fraction with an alcohol in the presence of a solid catalyst comprising a cation exchange resin and/or a sulfonic acid group-introduced amorphous carbon catalyst, following the first step.
(3) The method for producing a fatty acid monoester product according to (2), further comprising a fourth step of obtaining the fatty acid monoester product from an esterification reaction liquid obtained in the third step.
(4) The method for producing a fatty acid monoester product according to (2) or (3), wherein the cation exchange resin is a strongly acidic cation exchange resin.
(5) The method for producing a fatty acid monoester product according to any of (1) to (4), wherein the alcohol used is methanol or ethanol.
(6) The method for producing a fatty acid monoester product according to any of (1) to (5), wherein the fatty acid monoester product is a diesel fuel.
(7) A method for producing a fatty acid monoester product, comprising a first step of performing the transesterification reaction of an animal oil and/or a vegetable oil with an alcohol, or the esterification reaction of a fatty acid with an alcohol, in the presence of a sulfonic acid group-introduced amorphous carbon catalyst to obtain a fatty acid monoester product reaction liquid, wherein the sulfonic acid group-introduced amorphous carbon catalyst is a water-washed sulfonic acid group-introduced amorphous carbon catalyst washed with water after being used in the transesterification reaction of an animal oil and/or a vegetable oil with an alcohol, or the esterification reaction of a fatty acid with an alcohol.
(8) The method for producing a fatty acid monoester product according to (7), comprising a second step of removing glycerin, the alcohol, and water from the fatty acid monoester product reaction liquid to obtain a fatty acid monoester fraction, and a third step of contacting and reacting the fatty acid monoester fraction with an alcohol in the presence of a cation exchange resin and/or a sulfonic acid group-introduced amorphous carbon catalyst to obtain an esterification reaction liquid, following the first step.
(9) The method for producing a fatty acid monoester product according to (8), further comprising a fourth step of obtaining the fatty acid monoester product from the esterification reaction liquid obtained in the third step.
(10) The method for producing a fatty acid monoester product according to any of (7) to (9), wherein the fatty acid monoester product is a diesel fuel.

### Advantages of the Invention

By reacting an animal oil and the like with an alcohol in the presence of a sulfonic acid group-introduced amorphous carbon catalyst and water, the production of a fatty acid monoglyceride, which is difficult to separate from a fatty acid monoester, can be suppressed, and the fatty acid monoester can be efficiently produced.

By washing a sulfonic acid group-introduced amorphous carbon catalyst used for an esterification reaction or a transesterification reaction with water, the activity of this catalyst can be recovered. Thus, the life of an expensive catalyst can be extended, and the production cost can be reduced.

By performing, after the step of obtaining a fatty acid monoester product reaction liquid, the second step of obtaining a fatty acid monoester fraction, the third step of re-esterifying the fatty acid monoester fraction to obtain an esterification reaction liquid, and the fourth step of obtaining a fatty acid monoester product from the above esterification reaction liquid, a fatty acid monoester product having a low acid value can be produced.

### BRIEF DESCRIPTION OF THE DRAWINGS

FIG. 1 is a view showing a process for producing a fatty acid monoester in Examples; and

FIG. 2 is an explanatory view showing one example of a process for producing a fatty acid monoester product according to the present invention, comprising a catalyst washing step.

### DESCRIPTION OF SYMBOLS

5 . . . animal oil and/or vegetable oil,
5′ . . . animal oil and/or vegetable oil storage vessel,
10 . . . fatty acid monoester fraction,
15 . . . water,
15′ . . . water storage vessel,
20 . . . alcohol,
20′ . . . alcohol storage vessel,
25A, 25B . . . transesterification reactor,
27 . . . sulfonic acid group-introduced amorphous carbon catalyst,
30 . . . reboiler,
31 . . . heat exchanger
33 . . . waste water,
35 . . . fatty acid monoester fraction separation distillation column,
45 . . . glycerin separation vessel,

### BEST MODE FOR CARRYING OUT THE INVENTION

### (1) First Aspect

A first aspect of the present invention is a method for producing a fatty acid monoester product, comprising a first step of reacting an animal oil and/or a vegetable oil with an alcohol in the presence of a sulfonic acid group-introduced amorphous carbon catalyst and water to obtain a fatty acid monoester product reaction liquid.

If water is present in the transesterification reaction of a triglyceride included in an animal oil and the like with an alcohol, the triglyceride is hydrolyzed to produce a free fatty acid as a by-product. This free fatty acid is esterified to produce water as a by-product, and therefore, the equilibrium of the transesterification reaction transitions to the reverse reaction side. Therefore, conventionally, no water has been added to the transesterification reaction system. However, in the present invention, it has been found that when water is added to the transesterification reaction system, and a sulfonic acid group-introduced amorphous carbon catalyst is used as a transesterification catalyst, a fatty acid monoester product reaction liquid is obtained with the production of a fatty acid monoglyceride as a by-product very efficiently suppressed. The targeted fatty acid monoester product, water, and glycerin, as well as the fatty acid monoglyceride, a fatty acid diglyceride, the unreacted triglyceride, and the like can be mixed in the transesterification reaction liquid. But, the amount of fatty acid monoglyceride produced as a by-product, which is most difficult to separate from the targeted fatty acid monoester product for purification, can be suppressed, and therefore, the fatty acid monoester product can be produced more simply. Further, in the present invention, by using such a fatty acid monoester product reaction liquid, a fatty acid monoester product having a low total glycerin equivalent amount can be efficiently produced, and the obtained fatty acid monoester product can be preferably used as a diesel fuel. The present invention will be described below in detail.

### (1-1) Sulfonic Acid Group-Introduced Amorphous Carbon Catalyst

The “sulfonic acid group-introduced amorphous carbon catalyst” used in the present invention refers to a carbon having a sulfonic acid group, and not having a clear crystal structure like diamond and graphite.

The sulfonic acid group-introduced amorphous carbon used is not particularly limited as long as it can catalyze the transesterification reaction of an animal oil and/or a vegetable oil with an alcohol and the esterification reaction of an alcohol with a fatty acid. Those obtained by subjecting organic compounds to heat treatment in concentrated sulfuric acid or fuming sulfuric acid at a temperature of 0 to 350° C. can be preferably used. Examples of the organic compounds can include aromatic hydrocarbons, such as benzene, naphthalene, anthracene, perylene, and coronene; saccharides, such as monosaccharides, such as glucose, fructose, and galactose, and starch, cellulose, agarose, and oligosaccharide. These comprise a six-membered carbon ring structure in the structure, have a sulfonic acid group introduced by heat treatment with concentrated sulfuric acid or fuming sulfuric acid, and can exhibit excellent esterification or transesterification activity.

The sulfonic acid group-introduced amorphous carbon used in the present invention preferably has a sulfonic acid density of 1 to 8 mmol/g, more preferably 1 to 7 mmol/g, and particularly preferably 1.2 to 6 mmol/g, because in this range, the reaction efficiency of a fatty acid monoester product using a triglyceride and an alcohol as raw materials is high, the production rate of a monoglyceride as a by-product is low, and the efficiency of producing a fatty acid ester from an alcohol and a fatty acid is excellent.

The sulfonic acid group-introduced amorphous carbon used in the present invention can be obtained by subjecting the above organic compound to heat treatment in concentrated sulfuric acid or fuming sulfuric acid at a temperature of 0 to 350° C., preferably 60 to 250° C. If the treatment temperature is less than 0° C., the condensation and carbonization of the organic compound may not be sufficient. On the other hand, if the treatment temperature is more than 350° C., the pyrolysis of the sulfonic acid group may occur. The heat treatment time can be appropriately selected depending on the organic compound used, the treatment temperature, and the like, but is usually 15 minutes to 50 hours, preferably 1 to 20 hours. In this range of the reaction time, the partial carbonization, cyclization, condensation, and the like of the organic compound can proceed, and sulfonation can occur. Preferably, the heat treatment of the organic compound in concentrated sulfuric acid or fuming sulfuric acid is performed in the flow of an inert gas, such as nitrogen and argon, or in the flow of dry air. Thus, an amorphous carbon having high sulfonic acid density can be produced. More preferably, heating is performed while an inert gas, such as nitrogen and argon, or dry air is blown into concentrated sulfuric acid or fuming sulfuric acid to which the above organic compound is added. The reaction of the concentrated sulfuric acid with the aromatic hydrocarbon produces aromatic sulfonic acid and water. This reaction is an equilibrium reaction, and when the water in the reaction system increases, the reverse reaction proceeds fast. Therefore, the amount of sulfonic acid introduced into the amorphous carbon decreases significantly. However, an amorphous carbon having high sulfonic acid density can be synthesized by positively removing the water from the reaction system by performing the reaction in the flow of an inert gas or dry air, or performing the reaction while blowing these gases into the reaction system.

The amount of concentrated sulfuric acid or fuming sulfuric acid used is not particularly limited, but is usually 0.1 to 100 parts by mass, preferably 10 to 30 parts by mass, with respect to 1 part by mass of the organic compound. When saccharides, such as glucose and cellulose, are used as raw materials, preferably, these raw materials are heated in an inert gas flow at 100 to 350° C. for 1 to 20 hours for partial carbonization, before the heat treatment in the concentrated sulfuric acid or the fuming sulfuric acid.

Further, aromatic hydrocarbons, heavy oil, pitch, tar, and asphalt comprising aromatic hydrocarbons, and the like can be used as raw materials. In this case, preferably, the product is heated in a vacuum after the heat treatment in the concentrated sulfuric acid or the fuming sulfuric acid. This removes the excess sulfuric acid and promotes the carbonization and solidification of the product, and therefore, the product yield can be increased. For the evacuation, the treatment is preferably performed at an evacuation speed of 10 L/min or more, an ultimate pressure of 100 torr or less, and a heating temperature of 140 to 300° C., more preferably 200 to 280° C., for 2 to 20 hours.

For the sulfonic acid group-introduced amorphous carbon used in the present invention, for example, a carbon in which both the G-band and the D-band are detected in the spectrum in Raman spectroscopy and in which the integrated intensity ratio of the G-band to the D-band (I(D)/I(G)) is in the range of 0.1 to 0.7 can be preferably used. If the integrated intensity ratio (I(D)/I(G)) is less than 0.1, the number of gathered six-membered carbon rings is small, not providing a solid. If the integrated intensity ratio (I(D)/I(G)) is more than 0.7, the graphene sheet becomes large, and the sulfonic acid density decreases. Therefore, the carbon may not function as a catalyst. The integrated intensity ratio (I(D)/I(G)) should be in the range of 0.1 to 0.7, but is preferably in the range of 0.1 to 0.65, further preferably 0.2 to 0.65. In this description, the D-band, the G-band, and the integrated intensity of the D-band and the G-band are defined as follows.

The D-band is Alg breathing mode vibration in a six-membered carbon ring, and its peak top appears at 1350 cm⁻¹ to 1360⁻¹ cm. The G-band is Egg mode vibration in a six-membered carbon ring, and its peak top appears at 1580 cm⁻¹ ±5 cm⁻¹. A raman spectrum of the sum of the both peaks is peak-split into two by Gaussian or Gaussian-Lorentzian, and the obtained integrated intensity of the D-band and the G-band is the integrated intensity of the D-band and the G-band.

(1-2) Animal Oil and/or Vegetable Oil

In the present invention, an animal oil and/or a vegetable oil and an alcohol can be subjected to a transesterification reaction, using a transesterification reaction catalyst comprising the above sulfonic acid group-introduced amorphous carbon catalyst, to produce the corresponding fatty acid monoester product.

The “animal oil” used is an oil derived from an animal, and the concept of the animal oil includes an oil and fat. Examples of the animal oil that can be used in the present invention include fish oils obtained from fish body, such as sardine oil, mackerel oil, herring oil, saury oil, tuna oil, and cod liver oil; lard fat, chicken fat, butter fat, beef fat, beef bone fat, deer fat, dolphin fat, horse fat, lard, bone oil, mutton fat, neatsfoot oil, porpoise oil, shark oil, sperm whale oil, whale oil, and the like, and the animal oil is preferably one or more oils selected from the group consisting of fish oils, beef fat, and lard, and may be a mixture of these oils, an oil and fat comprising a diglyceride and a monoglyceride, or an oil in which modification, such as oxidation and reduction, occurs partially, because even if such raw materials are used, a fatty acid monoester product reaction liquid having a low production rate of a monoglyceride as a by-product (generally 0 to 1.3% by mass) can be obtained when the raw material is reacted in the presence of the above sulfonic acid group-introduced amorphous carbon catalyst and water under predetermined conditions. In the present invention, the production rate of a monoglyceride as a by-product refers to the proportion of a monoglyceride produced as a by-product when a case where raw materials all become a fatty acid ester product is 100% by mass.

Also, in the present invention, the “vegetable oil” is an oil derived from a vegetable, and the concept of the vegetable oil includes an oil and fat. Examples of the vegetable oil that can be used in the present invention include cocoa butter fat, corn oil, peanut oil, cottonseed oil, soybean oil, coconut oil, olive oil, safflower oil, tung oil, linseed oil, coconut oil, oak oil, almond oil, apricot kernel oil, castor oil, chaulmoogra oil, Shea butter, cottonseed oil, cottonseed stearin, sesame oil, palm oil, palm kernel oil, rice oil, kapok oil, and the like. The vegetable oil is more preferably one or more selected from sunflower oil, safflower oil, tung oil, linseed oil, soybean oil, rapeseed oil, cottonseed oil, olive oil, camellia oil, coconut oil, and palm oil, but is not limited to these. The vegetable oil may be a mixture of these oils, an oil and fat comprising a diglyceride and a monoglyceride, or an oil in which modification, such as oxidation and reduction, occurs partially, as described above.

The above animal oils and vegetable oils may be those directly extracted from raw material animals and vegetables, but may be those discarded after being used as edible oils and the like, because these comprise triglycerides as the main component, and therefore, fatty acid monoester products can be efficiently produced by transesterification. Examples of preferred triglycerides included in animal oils and the like can include triglycerides represented by the following formula:

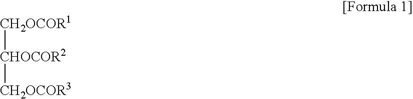

wherein R¹, R², and R³ are saturated or unsaturated hydrocarbon groups having 6 to 24 carbon atoms, which may have a substituent.

Examples of the substituents in R¹, R², and R³ included in the above triglycerides include a hydroxyl group, an amino group, a carbonyl group, a carboxyl group, and the like. The hydrocarbon groups included in the above triglycerides can be appropriately selected depending on the animal species and vegetable species of the raw materials.

The above animal oils and vegetable oils may comprise free fatty acids and moisture, because these can be removed in a second step and a third step described later to reduce the acid value. Generally, an animal oil and a vegetable oil extracted from an animal and a vegetable, or a waste animal oil and a waste vegetable oil after being used for food and the like comprise 1 to 5% by mass of a free fatty acid and 0% by mass of, to saturated, moisture. Dark oil produced as a by-product from an edible oil purification step contains 50 to 100% by mass of a free fatty acid. Rather, the method for producing a fatty acid monoester product according to the present invention is characterized in that fatty acid monoester products having a low acid value can be efficiently produced without removing free fatty acids and moisture from such raw materials.

### (1-3) Alcohol

The alcohol used in the present invention is not particularly limited, but alcohols represented by ROH wherein R represents a saturated or unsaturated hydrocarbon group having 1 to 24 carbon atoms are preferably used. Examples of the saturated or unsaturated hydrocarbon group having 1 to 24 carbon atoms among Rs include an alkyl group, an aralkyl group, an alkenyl group, an alkynyl group, and the like.

Examples of the alcohols in which R is an alkyl group include methanol, ethanol, n-propanol, isopropanol, n-butanol, isobutanol, t-butanol, pentanol, hexanol, cyclohexanol, heptanol, and the like.

Examples of the alcohols in which R is an aralkyl group include benzyl alcohol, α-phenethyl alcohol, and β-phenethyl alcohol. Benzyl alcohol is preferred.

Examples of the alcohols in which R is an alkenyl group include allyl alcohol, 1-methyl allyl alcohol, 2-methyl allyl alcohol, 3-butene-1-ol, 3-butene-2-ol, and the like. Allyl alcohol is preferred.

Examples of the alcohols in which R is an alkynyl group include 2-propyne-1-ol, 2-butyne-1-ol, 3-butyne-1-ol, 3-butyne-2-ol, and the like.

Among these, alcohols in which R is an alkyl group having 1 to 8, more preferably 1 to 4, carbon atoms are preferred, specifically, methanol, ethanol, 1-propanol, 2-propanol, 1-butanol, isobutyl alcohol, 2-butanol, t-butanol, and allyl alcohol, more preferably methanol and ethanol, and further preferably methanol. An alcohol may be used alone, or two or more alcohols may be mixed and used. Also, when an optical isomer is present, an alcohol may comprise the optical isomer.

### (1-4) First Step

In the present invention, the above animal oil and/or vegetable oil is reacted with an alcohol in the presence of a sulfonic acid group-introduced amorphous carbon catalyst and water.

The temperature during the reaction is generally 60 to 200° C., more preferably 70 to 180° C., and particularly preferably 90 to 160° C. Even if the temperature is less than 60° C., the transesterification reaction proceeds, but it takes time, and the productivity may decrease. On the other hand, even if the temperature is more than 200° C., the conversion rate is not improved, and by-products may be produced, which is disadvantageous.

The pressure during the reaction is generally atmospheric pressure to 5 MPa, more preferably atmospheric pressure to 4 MPa, and particularly preferably atmospheric pressure to 3 MPa. Even if the reaction pressure is lower than atmospheric pressure, the transesterification reaction proceeds, but a boiling state occurs, and the reaction volume increases, which is disadvantageous. On the other hand, even if the reaction pressure is more than 5 MPa, the conversion rate is not improved, and a thick-walled container is required to increase the pressure resistance of the reactor, which is economically disadvantageous.

The reaction time is time sufficient for the transesterification of a fatty acid triglyceride included in the above animal oil and/or vegetable oil with the above alcohol to obtain the corresponding fatty acid monoester product and glycerin. Generally, the reaction time is 10 minutes to 50 hours, more preferably 30 minutes to 30 hours, depending on the reaction conditions.

When 1 mole of the alcohol is reacted with 1 mole of fatty acid groups included in the animal oil and the vegetable oil in the above transesterification reaction, 1 mole of the corresponding fatty acid monoester product is produced. However, in the present invention, the alcohol is added with the molar ratio of the alcohol to 1 mole of fatty acid groups constituting a free fatty acid, a triglyceride, and a monoglyceride included in the animal oil and the vegetable oil (the alcohol/the fatty acid groups included in the animal oil and the vegetable oil) in the range of 1 to 40, more preferably 2 to 30, and particularly preferably 4 to 25. Thus, the fatty acid monoester product can be efficiently produced. If the above molar ratio is less than 1, the esterification reaction is insufficient. On the other hand, if the above molar ratio is more than 40, the reaction apparatus is huge, which is uneconomical.

The present invention is characterized in that the transesterification reaction involves water. Water may be externally added to the reaction system, or water included in the animal oil and the vegetable oil as raw materials may be used. The amount of water formulated is 0.1 to 20 moles, more preferably 0.15 to 15 moles, and particularly preferably 0.2 to 10 moles, with respect to 1 mole of the triglyceride included in the animal oil and the vegetable oil. Theoretically, when 1 mole of a triglyceride is reacted with 3 moles of water, 1 mole of glycerin and 3 moles of a fatty acid are produced by hydrolysis. But, in the present invention, water is added not for hydrolysis. Water is added because it has been found that the addition of water can suppress the production of a monoglyceride as a by-product, and it has become clear that this can make subsequent purification easy, and a diesel fuel having a low total glycerin equivalent amount and a low acid value can be produced. If the water is less than 0.1 moles, the effect of suppressing the production of a monoglyceride as a by-product is insufficient. On the other hand, if the water is more than 20 moles, the amount of free fatty acid may increase due to hydrolysis, which is disadvantageous. The above amount of “water” is the amount of moisture at the start of the reaction and does not include by-product water, which can be produced by the fatty acid mixed in the animal oil and/or the vegetable oil as the reaction proceeds.

The amount of a solid catalyst comprising the sulfonic acid group-introduced amorphous carbon catalyst of the present invention used is not particularly limited, but is preferably 10 to 1000 g, more preferably 20 to 500 g, with respect to 1 mole of the triglyceride.

The form of the apparatus for performing the production method of the present invention is not particularly defined. For example, a batch reactor, a continuous vessel reactor, a piston flow reactor, a column flow reactor, and the like can be used. The apparatus can be appropriately selected according to the oil and fat, the alcohol, and the solid catalyst used.

For example, a column is filled with the solid catalyst, and so on to form a fixed bed, and the above oil and fat, alcohol, and water are supplied to the fixed bed to react under the above reaction conditions. The obtained fatty acid monoester product reaction liquid comprises a fatty acid monoester product, which is the product, as well as the excess alcohol, glycerin produced as a by-product, water, and the like. But, a fatty acid monoester product reaction liquid in which the production rate of a monoglyceride as a by-product is generally 0 to 1.3% by mass, more preferably 0 to 1.0% by mass, can be obtained.

### (1-5) Second Step

A second step is the step of removing the above alcohol, glycerin, and water from the fatty acid monoester product reaction liquid obtained in the first step to obtain a fatty acid monoester fraction. The above fatty acid monoester product reaction liquid comprises the fatty acid monoester fraction comprising the fatty acid monoester product as the main component, as well as the glycerin and the excessively added alcohol.

(1) A method for introducing the fatty acid monoester product reaction liquid in the above first step into a distillation column, and selecting distillation conditions to distill the alcohol and the water from the column top, extract the glycerin from the middle of the column, and recover the fatty acid monoester product from the column bottom, (2) a method for introducing the above fatty acid monoester product reaction liquid into a distillation column, and selecting distillation conditions to distill the alcohol, the water, and the glycerin from the column top and recover the fatty acid monoester product from the column bottom, (3) a method for introducing the above fatty acid monoester product reaction liquid into a first distillation column, selecting distillation conditions to distill the alcohol and the water from the column top and extract the glycerin and the fatty acid monoester from the column bottom, then, introducing the column bottom liquid into a second distillation column for the separation and recovery of the glycerin and the fatty acid monoester product, (4) a method for introducing the fatty acid monoester product reaction liquid into a distillation column, distilling the methanol and the water, and then subjecting the fatty acid monoester product and the glycerin to liquid-liquid separation, and any other methods may be used as the method for fractionating the fatty acid monoester fraction. The above method (4) is preferred. In the present invention, a fraction obtained by removing the above glycerin, water, and alcohol from the fatty acid monoester product reaction liquid is the fatty acid monoester fraction.

### (1-6) Third Step

In the present invention, then, preferably, the above fatty acid monoester fraction is contacted and reacted with the above alcohol in the presence of a solid catalyst comprising a cation exchange resin and/or the above sulfonic acid group-introduced amorphous carbon catalyst. When the animal oil and/or the vegetable oil used as a raw material comprises a free fatty acid, the free fatty acid reacts with the alcohol to produce water as a by-product, and this by-product water may hydrolyze the produced fatty acid monoester product to produce a free fatty acid. This free fatty acid can be mixed in the fatty acid monoester fraction of the above second step. But, when the fatty acid monoester fraction is contacted with the alcohol in the presence of the above solid catalyst, the free fatty acid is esterified and removed from the above fatty acid monoester fraction, and the esterification of the free fatty acid can improve the esterification rate.

In the present invention, the sulfonic acid group-introduced amorphous carbon catalyst used in the first step can be used as such a solid catalyst, because the above sulfonic acid group-introduced amorphous carbon catalyst has catalytic action on a transesterification reaction and an esterification reaction. Also, a cation exchange resin can be used as another esterification reaction catalyst.

Strongly acidic cation exchange resins having a sulfonic acid group (R—SO₃⁻H⁺) as a functional group, and weakly acidic cation exchange resins having a carboxylic acid group, a sulfonic acid group, a phosphinic acid group, a phenoxide group, an arsenious acid group, and the like as a functional group can be preferably used as such a cation exchange resin. In the present invention, the cation exchange resin may be any resin as long as it can esterify the fatty acid included in the fatty acid monoester fraction. Preferably, the pK value (25° C.) is 0 to 7, more preferably 0 to 5. Particularly, strongly acidic cation exchange resins having a sulfonic acid group (R—SO₃⁻H⁺) as a functional group are preferred. Also, in the present invention, a cation exchange resin comprising a crosslinked styrene polymer or a crosslinked (meth)acrylate polymer is preferably used. Examples of the crosslinked styrene polymer include a crosslinked styrene-divinylbenzene (hereinafter abbreviated as DVB) polymer and the like. Its resin structure may be of a gel type, which is formed by simply polymerizing styrene and DVB, or may be of a porous type or a highly porous type, which is porous and has a much larger resin surface area than the gel type. In the present invention, the trade names “ORGANO AMBERLYST 15DRY,” “ORGANO AMBERLYST 15JS-HG/dry,” “ORGANO AMBERLYST 35Dry,” “AMBERLYST 36Dry,” and “AMBERLYST 70” manufactured by ORGANO CORPORATION, and the like can be preferably used. The solid catalyst may be used as a fixed bed or may be used with stirring.

In the third step of the present invention, the above fatty acid monoester fraction is contacted and reacted with the above alcohol in the presence of the above solid catalyst, and the free fatty acid that can be included in the fatty acid monoester fraction is re-esterified. For this re-esterification, for example, re-esterification may be performed while water is sequentially removed. By performing the esterification reaction while sequentially removing water, the esterification reaction time can be further reduced.

The reaction temperature in the esterification is generally a temperature of 25 to 200° C., more preferably 30 to 160° C., and particularly preferably 35 to 140° C. The esterification itself is possible even at more than 200° C., but the above solid catalyst may deteriorate at more than 200° C. On the other hand, at less than 25° C., the reaction time increases, which is disadvantageous. Also, the reaction pressure is not limited. When the above solid catalyst is used as a fixed bed, the esterification reaction can occur in a short time by making gas-liquid-solid contact in which the alcohol is supplied in the form of gas, or by bringing the fatty acid monoester fraction and the alcohol into solid-liquid contact with the above solid catalyst.

For the amount of alcohol used with respect to the above fatty acid monoester fraction, the alcohol is 0.007 to 2 parts by mass, more preferably 0.01 to 1.5 parts by mass, and particularly preferably 0.015 to 1 part by mass, with respect to 1 part by mass of the fatty acid monoester fraction. The amount of free fatty acid mixed in the fatty acid monoester fraction fractionated in the second step is slight, and the free fatty acid can be sufficiently efficiently esterified in the above range. If the alcohol is less than 0.007 parts by mass, the fatty acid monoester fraction undergoes a hydrolysis reaction due to a slight amount of water present, and the fatty acid may increase. On the other hand, if the alcohol is more than 2 parts by mass, excess energy is required in an alcohol recovery step, which is disadvantageous.

The form of the apparatus used in the third step is not particularly defined. A batch reactor, a continuous vessel reactor, a piston flow reactor, a column flow reactor, and the like can be used, as in the first step. For example, it is possible to supply the above fatty acid monoester fraction and alcohol to a reactor charged with the solid catalyst, control the reactor at a predetermined temperature and pressure, and bring the solid catalyst into solid-liquid contact, while suspending and stirring the solid catalyst, for an esterification reaction. The reactor may be charged with the solid catalyst as a fixed bed.

By this third step, the free fatty acid included in the fatty acid monoester fraction becomes a fatty acid monoester product, and the acid value can be reduced.

### (1-7) Fourth Step

On the other hand, the esterification reaction liquid obtained in the third step comprises the fatty acid monoester product and the alcohol and may further comprise by-product water produced in the esterification reaction. Then, by removing the alcohol from the above reaction liquid and removing a slight amount of the by-product water and the like present, a fatty acid monoester having higher purity can be produced. Particularly, even if the esterification reaction liquid obtained in the third step comprises the unreacted animal oil and/or vegetable oil, and a diglyceride, the high boiling point component, the unreacted animal oil and/or vegetable oil, the diglyceride, and the triglyceride can be removed by performing the fourth step of fractionating the fatty acid monoester product. Therefore, the total glycerin equivalent amount can be decreased.

A method for introducing the reaction liquid into a distillation column, selecting distillation conditions according to the above second step to distill the alcohol and the water from the column top and recover the fatty acid monoester product from the column bottom, further introducing the fatty acid monoester into vacuum distillation equipment, and distilling the fatty acid monoester product, and any other methods can be used as the method for separating and removing the alcohol, the water, the triglyceride, and the like from part of the above reaction liquid.

### (1-8) Diesel Fuel

The fatty acid monoester product of the present invention is produced by the above first step to third step and further the fourth step. Therefore, generally, the total glycerin equivalent amount is 0.24 or less, and the acid value is 0.5 or less. Particularly, the production rate of the monoglyceride as a by-product is a very low value in the first step, and therefore, the step of separating the monoglyceride from the fatty acid monoester product is unnecessary, and moreover, the acid value and the total glycerin equivalent amount can be reduced. Therefore, the obtained fatty acid monoester product can be preferably used as a diesel fuel.

For use as a diesel fuel, the total glycerin equivalent amount being 0.24% by mass or less and the acid value being 0.5 or less, as well as low viscosity, high volatility, no bad smell, and small amounts of black smoke and a SO_{X} component are preferred. The fatty acid monoester product has a small amount of a SOx component because the raw materials are the vegetable oil and the animal oil, and the fatty acid monoester product has no bad smell because the fatty acid monoester fraction is isolated after the esterification reaction. Also, a fatty acid ester product has high volatility. Therefore, the fatty acid monoester can be preferably used as a diesel fuel. Also, the fatty acid monoester product produced according to the present invention can be used as a diesel fuel, as well as added to light oil, kerosene, heavy oil A, and the like and used for other fuels and the like.

Raw materials of the fatty acid monoester product produced according to the present invention are biomass resources incorporated in the circulatory system of the earth, and the fatty acid monoester largely contributes to a reduction in the load on the environment, compared with light oil derived from fossil resources. The production method of the present invention can also be largely expected as a mass treatment technique for industrial and domestic wastes, such as waste edible oils after being used for cooking and the like, particularly a technique for selectively and effectively converting them into useful compounds.

### (2) Second Aspect

A second aspect of the present invention is a method for producing a fatty acid monoester product, comprising the first step of performing the transesterification reaction of an animal oil and/or a vegetable oil with an alcohol, or the esterification reaction of a fatty acid with an alcohol, in the presence of a water-washed sulfonic acid group-introduced amorphous carbon catalyst (a sulfonic acid group-introduced amorphous carbon catalyst washed with water after being used in the transesterification reaction of an animal oil and/or a vegetable oil with an alcohol, or the esterification reaction of a fatty acid with an alcohol) to obtain a fatty acid monoester product reaction liquid.

It has become clear that when a sulfonic acid group-introduced amorphous carbon catalyst is used in the transesterification reaction of a triglyceride included in an animal oil and the like with an alcohol, and the esterification reaction of a fatty acid with an alcohol, the transesterification rate and the esterification rate decrease over time. Also, it has become clear that this decrease in catalytic activity can be recovered by washing the sulfonic acid group-introduced amorphous carbon catalyst with water. The present invention will be described below in detail.

### (2-1) Sulfonic Acid Group-Introduced Amorphous Carbon Catalyst

The water-washed sulfonic acid group-introduced amorphous carbon catalyst used in the present invention is prepared from a sulfonic acid group-introduced amorphous carbon catalyst by a method described later. The original sulfonic acid group-introduced amorphous carbon catalyst may be similar to the one used in the first aspect.

### (2-2) Animal Oil, Vegetable Oil, and Fatty Acid

In the present invention, a fatty acid monoester product is produced using an animal oil, a vegetable oil, a fatty acid, and the like as raw materials. The animal oil and the vegetable oil used may be similar to those used in the first aspect. As the fatty acid, fatty acids generally having 8 to 24 carbon atoms, more preferably 12 to 22 carbon atoms, and particularly preferably 14 to 22 carbon atoms can be used. Examples of such fatty acids can include free fatty acids obtained by hydrolyzing animal oils and/or vegetable oils, and the like.

### (2-3) Alcohol

The alcohol used in the present invention may be similar to the one used in the first aspect.

### (2-4) First Step

The first step of the present invention is the step of performing the transesterification reaction of an animal oil and/or a vegetable oil with an alcohol, or the esterification reaction of a fatty acid with an alcohol, in the presence of a water-washed sulfonic acid group-introduced amorphous carbon catalyst to obtain a fatty acid monoester product reaction liquid.

### (i) Water-Washed Sulfonic Acid Group-Introduced Amorphous Carbon Catalyst

The water-washed sulfonic acid group-introduced amorphous carbon catalyst is prepared from a catalyst used in the transesterification reaction of an animal oil and/or a vegetable oil with an alcohol, or the esterification reaction of a fatty acid mixed in an animal oil and/or a vegetable oil with an alcohol. Also, the water-washed sulfonic acid group-introduced amorphous carbon catalyst may be prepared from a catalyst used in both a transesterification reaction and an esterification reaction.

The conditions of these reactions are not particularly limited, but may be, for example, the reaction conditions of a transesterification reaction described later.

In the present invention, the catalyst used in the above reaction is washed with water. The transesterification reaction generally involves a reaction system comprising no water, and therefore, resistance and the like when the catalyst is treated with water are problems. However, a study of various activation methods has proved that the activity of the sulfonic acid group-introduced amorphous carbon catalyst used in the present invention is recovered most by water washing.

The regeneration method by water washing is not limited. For example, the sulfonic acid group-introduced amorphous carbon catalyst can be regenerated by adding water in an amount 1 to 20 times by mass the amount of catalyst, stirring the materials at a temperature of 0 to 100° C. for 5 minutes to 1 hour, and drying the materials at a temperature of 50 to 150° C. after the stirring. Water in an amount 0.5 to 20 times by mass the amount of catalyst may be flowed at a flow rate of 3 to 200 mm/min for washing, without stirring in water. A reactor is filled with the sulfonic acid group-introduced amorphous carbon catalyst in the form of slurry or as a fixed bed. Therefore, after the completion of the above reaction, the reaction liquid is removed, then, the reactor is charged with water, and the catalyst remaining in the reactor is washed in a batch manner. Alternatively, water can be continuously flowed into the reactor to continuously wash the catalyst with the water.

In the present invention, the “water” used to wash the catalyst may comprise the above alcohol in the range of 20% by mass or less, because when the alcohol content is in the above range, the activity of the sulfonic acid group-introduced amorphous carbon catalyst can be recovered by water washing. Also, water discharged in the process for producing the fatty acid monoester product may comprise the alcohol used in the reaction system and can be subjected to fractional distillation and reused as water and the alcohol in the process. But, the water containing the alcohol can be recovered under reduced distillation conditions and used for washing the catalyst, thereby reducing the production cost.

The activity of the sulfonic acid group-introduced amorphous carbon catalyst used in the present invention is recovered by water washing. But, the activity of the water-washed sulfonic acid group-introduced amorphous carbon catalyst also decreases over time through batch or continuous transesterification reactions. Such a catalyst can also be used as the water-washed sulfonic acid group-introduced amorphous carbon catalyst in the present invention by washing the catalyst with water again.

The reason that the activity of the sulfonic acid group-introduced amorphous carbon catalyst is recovered by water washing is not clear, but is presumed as follows. It is considered that the sulfonic acid group-introduced amorphous carbon catalyst catalyzes a transesterification reaction or an esterification reaction by the introduced sulfonic acid group. However, if a large amount of an alcohol is present in the reaction system, the sulfonic acid group becomes alkoxy due to this alcohol, and the activity decreases. The alkoxy returns to the original sulfonic acid group by water washing, thereby recovering the activity. From the above, it is presumed that the recovery of activity by water washing is found not only in the transesterification reaction and the esterification reaction, but also in general reactions using alcohols. Examples of the reactions, other than the transesterification reaction and the esterification reaction, in which the recovery of activity by water washing can be expected include an ether synthesis reaction, a Diels-Alder reaction, a Michael reaction, a Friedel-Crafts reaction, Schiff base synthesis, Fries rearrangement, the hydrolysis of an ester, amide, and nitrile, a hydration reaction, ether bond cleavage, the methylolation reaction of a benzene nucleus, an aldol reaction, a Mannich reaction, an oxidation reaction with hydrogen peroxide, organic peroxide, or molecular oxygen, and further the dehydration reaction of an alcohol, an O-glycosylation reaction, and the like. Application to the polymerization reactions of olefins, and the like is also possible.

### (ii) Transesterification Reaction

In the present invention, the transesterification reaction of an animal oil and/or a vegetable oil with an alcohol is performed in the presence of a water-washed sulfonic acid group-introduced amorphous carbon catalyst.

Water may or may not be present in the reaction system. When water is present, the amount of water formulated may be similar to that in the first aspect.

The temperature during the reaction is generally 60 to 200° C., more preferably 70 to 180° C., and particularly preferably 90 to 160° C. Even if the temperature is less than 60° C., the transesterification reaction proceeds, but it takes time, and the productivity may decrease. On the other hand, even if the temperature is more than 200° C., the conversion rate is not improved, and by-products may be produced, which is disadvantageous.

The pressure during the reaction is generally atmospheric pressure to 5 MPa, more preferably atmospheric pressure to 4 MPa, and particularly preferably atmospheric pressure to 3 MPa. Even if the reaction pressure is lower than atmospheric pressure, the transesterification reaction proceeds, but a boiling state occurs, and the reaction volume increases, which is disadvantageous. On the other hand, even if the reaction pressure is more than 5 MPa, the conversion rate is not improved, and a thick-walled container is required to increase the pressure resistance of the reactor, which is economically disadvantageous.

The reaction time is time sufficient for the transesterification of a fatty acid triglyceride included in the above animal oil and/or vegetable oil with the above alcohol to obtain the corresponding fatty acid monoester product and glycerin. Generally, the reaction time is 10 minutes to 50 hours, more preferably 30 minutes to 30 hours, depending on the reaction conditions.

When 1 mole of the alcohol is reacted with 1 mole of fatty acid groups included in the animal oil and the vegetable oil in the above transesterification reaction, 1 mole of the corresponding fatty acid monoester product is produced. However, in the present invention, the alcohol is added with the molar ratio of the alcohol to 1 mole of fatty acid groups constituting a free fatty acid, a triglyceride, and a monoglyceride included in the animal oil and the vegetable oil (the alcohol/the fatty acid groups included in the animal oil and the vegetable oil) in the range of 1 to 40, more preferably 2 to 30, and particularly preferably 4 to 25. The above animal oil and/or vegetable oil may comprise a fatty acid. By adding the alcohol in the above range, the fatty acid monoester product can be efficiently produced. If the above molar ratio is less than 1, the esterification and the transesterification reaction are insufficient. On the other hand, if the above molar ratio is more than 40, the reaction apparatus is huge, which is uneconomical.

The amount of the water-washed sulfonic acid group-introduced amorphous carbon catalyst of the present invention used is not particularly limited, but is preferably 10 to 1000 g, more preferably 20 to 500 g, with respect to 1 mole of the triglyceride.

The form of the apparatus for performing the production method of the present invention is not particularly defined. For example, a batch reactor, a continuous vessel reactor, a piston flow reactor, a column flow reactor, and the like can be used. The apparatus can be appropriately selected according to the oil and fat and the alcohol used.

For example, a column is filled with the water-washed sulfonic acid group-introduced amorphous carbon catalyst, and so on to form a fixed bed, and the above oil and fat, alcohol, and water are supplied to the fixed bed to react under the above reaction conditions. The obtained fatty acid monoester product reaction liquid comprises the fatty acid monoester product, which is the product, as well as the excess alcohol, glycerin produced as a by-product, water, and the like. According to the present invention, a fatty acid monoester product reaction liquid in which the production rate of a monoglyceride as a by-product is generally 0 to 1.3% by mass, more preferably 0 to 1.0% by mass, can be obtained.

(iii) Esterification Reaction

In the present invention, the esterification reaction of a fatty acid with an alcohol is performed in the presence of a water-washed sulfonic acid group-introduced amorphous carbon catalyst.

Water may or may not be present in the reaction system. When water is present, the amount of water formulated may be similar to that in the first aspect.

The temperature during the reaction is generally 25 to 200° C., more preferably 30 to 160° C., and particularly preferably 35 to 145° C. The esterification itself is possible even at more than 200° C., but the above catalyst may deteriorate at more than 200° C. On the other hand, at less than 25° C., the reaction time increases, which is disadvantageous.

The pressure during the reaction is not limited, but is a pressure at which an amount of an alcohol liquid required to react the fatty acid with the alcohol can be obtained.

The reaction time is time sufficient to esterify the fatty acid and the alcohol to produce the fatty acid ester product. Generally, the reaction time is 10 minutes to 50 hours, more preferably 30 minutes to 30 hours, depending on the reaction conditions.

For the amount of alcohol used with respect to the fatty acid, the alcohol is 4 to 50 parts by mass, preferably 5 to 50 parts by mass, more preferably 5 to 40 parts by mass, and particularly preferably 7 to 40 parts by mass, with respect to 1 part by mass of the fatty acid. If the alcohol is less than 4 parts by mass, the esterification does not proceed sufficiently. On the other hand, if the alcohol is more than 50 parts by mass, excess energy is required in an alcohol recovery step, which is disadvantageous. Particularly, it is necessary to reduce the amount of water and unreacted fatty acid to reduce the acid value of the obtained fatty acid monoester product. In the above range, the esterification reaction rate is improved, the amount of unreacted fatty acid is reduced, and a fatty acid monoester having an acid value of 0.5 or less can be obtained. In the esterification reaction, when the above acid value cannot be satisfied in a one-step esterification reaction, the esterification reaction may be performed in multiple steps while water is removed. Thus, a fatty acid monoester product having a low acid value can be efficiently obtained.

The form of the apparatus used in the esterification reaction is not particularly defined. A batch reactor, a continuous vessel reactor, a piston flow reactor, a column flow reactor, and the like can be used. For example, it is possible to supply the above fatty acid and alcohol to a reactor charged with the above water-washed sulfonic acid group-introduced amorphous carbon catalyst, control the reactor at a predetermined temperature and pressure, and bring the catalyst into solid-liquid contact, while suspending and stirring the catalyst, for an esterification reaction. The reactor may be charged with the water-washed sulfonic acid group-introduced amorphous carbon catalyst as a fixed bed.

### (2-5) Second Step

A second step can be performed as in the second step of the first aspect.

### (2-6) Third Step

A third step can also be performed as in the third step of the first aspect.

### (2-7) Fourth Step

A third step can also be performed as in the fourth step of the first aspect.

### (2-8) Diesel Fuel

The fatty acid monoester product produced in the second aspect can also be preferably used as a diesel fuel, as in the fatty acid monoester product produced in the first aspect.

### Examples

The present invention will be described below in more detail by Examples, but the following Examples do not limit the present invention, and any change in design within the above and the following spirit is included in the technical range of the present invention.

### Production Example 1

### Preparation of Catalyst (1)

20 g of D-glucose was heated at 400° C. in the flow of a nitrogen gas for 15 hours to obtain a carbonaceous powder. This powder was heated at 150° C. for 15 hours, while being stirred in 200 ml of 15% by mass of fuming sulfuric acid, to obtain a black powder. The black powder was repeatedly washed in distilled water to remove sulfuric acid included in the powder to obtain a sulfonic acid group-introduced amorphous carbon (I).

The sulfonic acid density of this sulfonic acid group-introduced amorphous carbon was 1.5 mmol/g.

Also, the integrated intensity ratio of the G-band to the D-band (I(D)/I(G)) in a Raman spectrum was 0.59.

The measurement of the sulfonic acid density was performed by the following method.

Most of sulfur elements included in the above sulfone were derived from a sulfonic acid group, and therefore, the sulfur in the sample was quantified by element analysis with a fuel (SX-Elements Micro Analyzer YS-10 (yanaco) and converted to the amount of sulfonic acid.

Also, the measurement of the integrated intensity ratio of the G-band to the D-band (I(D)/I(G)) in a Raman spectrum was performed by the following method.

The sample powder was placed in the sample holder of an NRS-2100 type triple monochromator Raman spectrophotometer (JASCO Corporation), and a Raman spectrum was measured. A Raman spectrum in which two bands, the G-band to the D-band, were observed was split into two peaks of the G-band to the D-band by Gaussian or Gaussian-Lorentzian, and the obtained integrated intensity of the D-band and the G-band is the integrated intensity of the D-band and the G-band.

### Production Example 2

### Preparation of Catalyst (2)

Operations were performed as in Production Example 1 except that a cellulose having a degree of crystallinity of 80% and a degree of polymerization of 200 to 300 was used instead of the D-glucose and that the conditions were changed to those shown in Table 1, to produce a sulfonic acid group-introduced amorphous carbon (II).

TABLE 1

| | | Concentrated sulfuric | Heating | Heating | Sulfonic acid | |
|---|---|---|---|---|---|---|
| Production | Organic | acid or fuming sulfuric | temperature | time | density | |
| Example | Compound | acid | (° C.) | (H) | (mmol/g) | (I(D)/I(G)) |
| 1 | D-glucose | Fuming sulfuric acid | 150 | 15 | 1.5 | 0.59 |
| 2 | Cellulose | Fuming sulfuric acid | 80 | 10 | 2.0 | 0.55 |

### Example 1-1

2.66 g of glycerin trioleate and 0.36 g of the transesterification reaction catalyst prepared in Production Example 2 were weighed into the pressurized glass test tube of a Personal Organic Synthesizer (ChemiStation) PPS-2510 manufactured by TOKYO RIKAKIKAI CO., LTD., and 4.16 g of methanol and 0.18 g of water were added. The test tube was capped and sealed. The molar ratio of the fatty acid group constituting the glycerin trioleate to the supplied methanol (the supplied methanol/the fatty acid group) was 14.4. The amount of catalyst with respect to 1 mole of the glycerin trioleate was 121 g.

These were heated at 130° C. at a pressure of about 800 kPa for 5 hours to obtain a fatty acid monoester product reaction liquid. The yield was 95.8 (% by mass), the oleic acid was 2.5 (% by mass), and the oleic acid monoglyceride was 0 (% by mass). The composition of a liquid (vaporized liquid) distilled from the transesterification reactor was also measured. The results are shown in Table 2.

TABLE 2

| Reaction system (g) | | | | | | |
|---|---|---|---|---|---|---|
| Amount of | | | | Product (% by mass) | | |
| catalyst | Triolein | Methanol | Water | Oleic acid | Monoglyceride | Methyl oleate |
| 0.36 | 2.66 | 4.16 | 0.18 | 2.5 | 0 | 95.8 |

| | | | |
|---|---|---|---|
| Vaporized liquid | 82.6 | 0 | 17.4 |

### Example 1-2

The fatty acid monoester product reaction liquid obtained in Example 1-1 (a first step) was evaporated at reduced pressure and then allowed to stand still to be separated into two layers to provide the upper layer as a fatty acid monoester fraction (a second step). The percentage by mass of the triglyceride (TG), the diglyceride (DG), the monoglyceride (MG), the fatty acid (FA), and the fatty acid monoester (FAME) included in this fatty acid monoester fraction with respect to the total amount is shown in Table 3.

TABLE 3

| | TG | DG | MG | FA | FAME |
|---|---|---|---|---|---|
| Mass (%) | 0 | 1.9 | 0 | 8.5 | 89.7 |

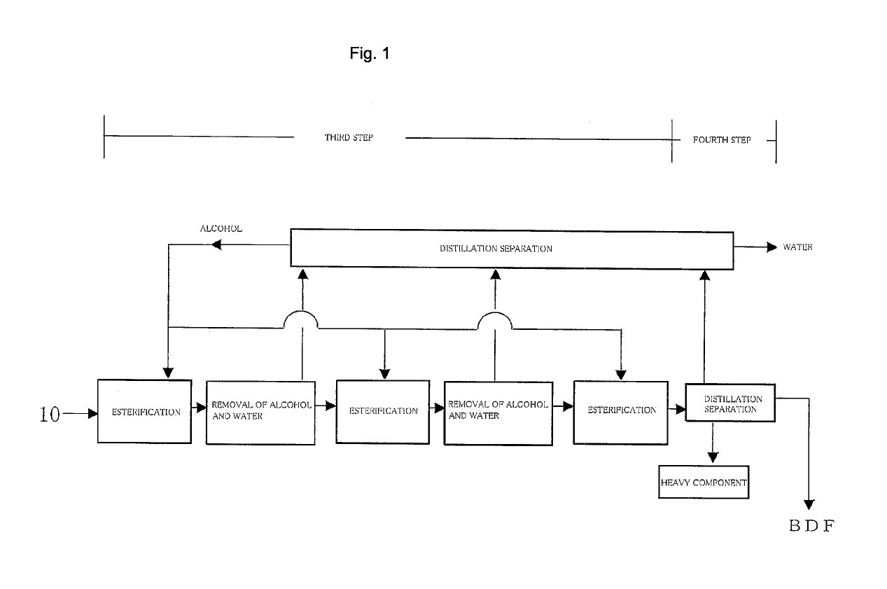

Then, a third step and a fourth step were performed according to a process shown in FIG. 1. The pressurized glass test tube of the Personal Organic Synthesizer (ChemiStation) PPS-2510 manufactured by TOKYO RIKAKIKAI CO., LTD. charged with 0.15 g of the sulfonic acid group-introduced amorphous carbon catalyst prepared in Production Example 2 was charged with 9 g of the fatty acid monoester fraction with the composition shown in the above Table 3 and 2.6 g of methanol. The molar ratio of the methanol to the fatty acid included in the fatty acid monoester fraction (the supplied methanol/fatty acid molar ratio) was 32. A stirring bar was placed in the glass test tube and rotated at 1200 rpm. While the temperature was kept at 95° C., and the pressure was kept as it was (at about 150 kPa gauge), the above solid catalyst, the oil component, and the methanol in the glass test tube were stirred and mixed for an esterification reaction for 4 hours. Further, the pressure was reduced with the contents kept in the ChemiStation test tube, the operation of removing the methanol and water in the test tube was performed, and the catalyst was solid-liquid separated to obtain a fatty acid monoester product (a third step). The liquid comprised 1.3% by mass of a fatty acid diglyceride and 98.6% by mass of a fatty acid monoester, and the acid value was 0.2.

Then, the above reaction liquid was transferred to a rotary evaporator. The rotary evaporator was evacuated, and the reaction liquid was heated at an oil bath temperature of 185° C. to distill the fatty acid monoester (a fourth step). In the liquid, the esterification rate was 99.8% or more, the total glycerin equivalent amount was 0, and the acid value was 0.2. It is presumed that the diglyceride remained in the rotary evaporator.

### Example 1-3

1.70 g (2 mmol) of glycerin trioleate and 0.23 g of the transesterification reaction catalyst prepared in Production Example 2 were weighed into the pressurized glass test tube of the Personal Organic Synthesizer (ChemiStation) PPS-2510 manufactured by TOKYO RIKAKIKAI CO., LTD., and 3.81 g of methanol and 0.023 g of water were added. The test tube was capped and sealed. The molar ratio of the fatty acid group constituting the glycerin trioleate to the supplied methanol (the supplied methanol/the fatty acid group) was 20. The amount of catalyst with respect to 1 mole of the glycerin trioleate was 115 g. These were heated at 130° C. for 5 hours to obtain a fatty acid monoester product reaction liquid (a first step). The yield was 98.1 (% by mass), the oleic acid was 0.5 (% by mass), and the oleic acid monoglyceride was 0.3 (% by mass). The results are shown in Table 4.

Then, the fatty acid monoester product reaction liquid obtained in the first step was evaporated at reduced pressure and then allowed to stand still. Then, the reaction liquid separated into two layers to provide the upper layer as a fatty acid monoester fraction (a second step). The percentage by mass of the triglyceride (TG), the diglyceride (DG), the monoglyceride (MG), the fatty acid (FA), and the fatty acid monoester (FAME) included in this fatty acid monoester fraction with respect to the total amount is shown in Table 5.

Then, a third step and a fourth step were performed according to the process shown in FIG. 1. The ordinary-pressure glass test tube of the Personal Organic Synthesizer (ChemiStation) PPS-2510 manufactured by TOKYO RIKAKIKAI CO., LTD. charged with 2 g of a cation ion exchange resin (manufactured by ORGANO CORPORATION, the trade name “ORGANO AMBERLYST 15JS-HG/dry” was charged with 5 g of the fatty acid monoester fraction shown in the above Table 5 and 1.3 g of methanol. The molar ratio of the methanol to the fatty acid included in the fatty acid monoester fraction (the supplied methanol/fatty acid molar ratio) was 80. A stirring bar was placed in the glass test tube and rotated at 1200 rpm. While the temperature was kept at 64° C., and the pressure was kept at atmospheric pressure, the above solid catalyst, the oil component, and the methanol in the glass test tube were stirred and mixed for an esterification reaction for 4 hours. Further, the pressure was reduced with the contents kept in the ChemiStation test tube, the operation of removing the methanol and water in the test tube was performed, and the catalyst was solid-liquid separated to obtain a fatty acid monoester product (a third step). The liquid comprised the triglyceride (TG), 1.0% by mass of the fatty acid diglyceride (DG), 0.5% by mass of the monoglyceride (MG), and 98.3% by mass of the fatty acid monoester (FAME), and the acid value was 0.4 (corresponding to 0.2% by mass of FA). The results are shown in Table 5.

Then, the above reaction liquid was transferred to the rotary evaporator. The rotary evaporator was evacuated, and the reaction liquid was heated at an oil bath temperature of 185° C. to distill the fatty acid monoester. In the liquid, the esterification rate was 99.6% or more, the total glycerin equivalent amount was 0.1% by mass, and the acid value was 0.4. It is presumed that the diglyceride remained in the rotary evaporator. (a fourth step)

TABLE 4

| Reaction system (g) | | | | | | |
|---|---|---|---|---|---|---|
| Amount of | | | | Product (% by mass) | | |
| catalyst | Triolein | Methanol | Water | Oleic acid | Monoglyceride | Methyl oleate |
| 0.36 | 1.70 | 3.81 | 0.02 | 0.5 | 0.3 | 98.1 |

| | | | |
|---|---|---|---|
| Vaporized liquid | 51.7 | 2.9 | 45.3 |

TABLE 5

| | TG | DG | MG | FA | FAME |
|---|---|---|---|---|---|
| Second step | 0 | 1.1 | 0.5 | 3.3 | 95.1 |
| Third step | 0 | 1.0 | 0.5 | Unmeasured | 98.3 |

### Comparative Example 1-1

### (No Water Added)

3.55 g (4 mmol) of glycerin trioleate and 0.48 g of the transesterification reaction catalyst prepared in Production Example 2 were weighed into the pressurized glass test tube of the Personal Organic Synthesizer (ChemiStation) PPS-2510 manufactured by TOKYO RIKAKIKAI CO., LTD., 3.85 g of methanol was added, and no water was added. The test tube was capped and sealed. The molar ratio of the supplied methanol to the fatty acid group constituting the glycerin trioleate (the supplied methanol/the fatty acid group) was 10. The amount of catalyst with respect to 1 mole of the glycerin trioleate was 121 g. These were heated at 130° C. for 5 hours to obtain a fatty acid monoester product reaction liquid (a first step). The results are shown in Table 6.

The fatty acid monoester product reaction liquid obtained in the first step was evaporated at reduced pressure and then allowed to stand still. Then, the reaction liquid separated into two layers to provide the upper layer liquid as a fatty acid monoester fraction (a second step). The percentage by mass of the triglyceride (TG), the diglyceride (DG), the monoglyceride (MG), the fatty acid (FA), and the fatty acid monoester (FAME) included in this fatty acid monoester fraction with respect to the total amount is shown in Table 7.

A third step and a fourth step were performed according to the process shown in FIG. 1. The ordinary-pressure glass test tube of the Personal Organic Synthesizer (ChemiStation) PPS-2510 manufactured by TOKYO RIKAKIKAI CO., LTD. charged with 2 g of a cation ion exchange resin (manufactured by ORGANO CORPORATION, the trade name “ORGANO AMBERLYST 15JS-HG/dry” was charged with 5 g of the fatty acid monoester fraction and 1.3 g of methanol. The molar ratio of the methanol to the fatty acid included in the fatty acid monoester fraction (the supplied methanol/fatty acid molar ratio) was 70. A stirring bar was placed in the glass test tube and rotated at 1200 rpm. While the temperature was kept at 64° C., and the pressure was kept at atmospheric pressure, the above solid catalyst, the oil component, and the methanol in the glass test tube were stirred and mixed for an esterification reaction for 4 hours. Further, the pressure was reduced with the contents kept in the ChemiStation test tube, the operation of removing the methanol and water in the test tube was performed, and the catalyst was solid-liquid separated to obtain a fatty acid monoester product (a third step). The liquid comprised 0% by mass of the triglyceride (TG), 1.3% by mass of the fatty acid diglyceride (DG), 1.3% by mass of the monoglyceride (MG), and 97.2% by mass of the fatty acid monoester (FAME), and the acid value was 0.35 (corresponding to 0.18% by mass of FA). The results are shown in Table 7.

Then, the above reaction liquid was transferred to the rotary evaporator. The rotary evaporator was evacuated, and the reaction liquid was heated at an oil bath temperature of 185° C. to distill the fatty acid monoester. In the liquid, the esterification rate was 99.6% or more, and the total glycerin equivalent amount was 0.3% by mass. The standard value was 0.24 or more. (a fourth step)

TABLE 6

| Reaction system (g) | | | | | | |
|---|---|---|---|---|---|---|
| Amount of | | | | Product (% by mass) | | |
| catalyst | Triolein | Methanol | Water | Oleic acid | Monoglyceride | Methyl oleate |
| 0.48 | 3.55 | 3.85 | 0 | 1.46 | 1.5 | 96.2 |

TABLE 7

| | TG | DG | MG | FA | FAME |
|---|---|---|---|---|---|
| Second step | 0 | 1.4 | 1.4 | 3.7 | 93.5 |
| Third step | 0 | 1.3 | 1.3 | Unmeasured | 97.2 |

### Comparative Example 1-2

The Personal Organic Synthesizer (ChemiStation) PPS-2510 manufactured by TOKYO RIKAKIKAI CO., LTD. was changed to a pressurized type. 4.5 g (5 mmol) of glycerin trioleate and 4 g of a cation ion exchange resin (manufactured by ORGANO CORPORATION, the trade name “ORGANO AMBERLYST 15JS-HG/dry” were weighed into a glass test tube, and 9.4 g of ethanol was added. The test tube was capped and sealed. The molar ratio of the supplied ethanol to the glycerin trioleate (the supplied ethanol/glycerin trioleate molar ratio) was 40. The amount of catalyst with respect to 1 mole of the glycerin trioleate was 786 g. These were heated at 130° C. for 6 hours to obtain a fatty acid monoester product reaction liquid (a first step). The esterification rate was 12%.

### Example 2-1

2.66 g of glycerin trioleate and 0.36 g of the transesterification reaction catalyst prepared in Production Example 2 were weighed into the pressurized glass test tube of the Personal Organic Synthesizer (ChemiStation) PPS-2510 manufactured by TOKYO RIKAKIKAI CO., LTD., and 4.16 g of methanol and 0.18 g of water were added. The test tube was capped and sealed. These were heated at 130° C. at a pressure of 700 kPa for 5 hours to obtain a fatty acid monoester product reaction liquid. The yield of the fatty acid monoester was 95.8 (%), the oleic acid was 2.47 (%), and the oleic acid monoglyceride was 0(%). The composition of the fatty acid monoester product reaction liquid is shown in Table 8.

Then, the above catalyst was washed with water in a volume 10 to 15 times the volume of the catalyst for about 10 minutes, then drained with filter paper, and dried at 130° C. for 3 hours to prepare a water-washed sulfonic acid group-introduced amorphous carbon catalyst. Then, using this water-washed sulfonic acid group-introduced amorphous carbon catalyst, transesterification was performed twice under conditions in Table 8. The composition of the obtained fatty acid monoester product reaction liquid is shown in Table 8.

### Comparative Example 2-1

After the two transesterification reactions with the water-washed sulfonic acid group-introduced amorphous carbon catalyst in Example 2-1, a transesterification reaction was performed three times under conditions shown in Table 2, without washing the catalyst with water. The composition of the obtained fatty acid monoester product reaction liquid is shown in Table 8.

As is clear from the fourth, fifth, and sixth transesterification reactions in Table 8, the activity decreased extremely when the water washing was not performed after the reaction.

### Example 2-2

After the transesterification reactions in Comparative Example 2-1, the above catalyst was washed with water in a volume 10 to 15 times the volume of the catalyst for about 10 minutes, then drained with filter paper, and dried at 130° C. for 3 hours to prepare a water-washed sulfonic acid group-introduced amorphous carbon catalyst. Then, using this water-washed sulfonic acid group-introduced amorphous carbon catalyst, transesterification was performed twice under conditions in Table 8. The composition of the obtained fatty acid monoester product reaction liquid is shown in Table 8. When the transesterification reaction was performed after the catalyst used six times in Comparative Example 2-1 was washed with water, the seventh transesterification rate recovered to the second reaction efficiency.

TABLE 8

| Number | Amount of | Triolein | Methanol | Water | Reaction | Yield | |
|---|---|---|---|---|---|---|---|
| of times | catalyst (g) | (g) | (g) | (g) | time (H) | (%) | Water washing |
| 1 | 0.36 | 2.66 | 4.16 | 0.18 | 6 | 95.8 | — |
| 2 | 0.57 | 4.21 | 6.59 | 0.285 | 4 | 86.4 | Water washing |
| 3 | 0.55 | 4.06 | 6.36 | 0.275 | 4 | 76.0 | Water washing |
| 4 | — | 4.06 | 6.36 | 0.275 | 4 | 44.3 | — |
| 5 | — | 4.06 | 6.36 | 0.275 | 4 | 38.0 | — |
| 6 | — | 4.06 | 6.36 | 0.275 | 4 | 38.2 | — |
| 7 | 0.5 | 3.69 | 6.17 | 0.275 | 7 | 84.2 | Water washing |
| 8 | 0.46 | 3.40 | 5.94 | 0 | 7 | 90.1 | Water washing |

### Comparative Example 2-2

4.26 g of oleic acid and 0.3 g of the transesterification reaction catalyst prepared in Production Example 1 were weighed into the pressurized glass test tube of the Personal Organic Synthesizer (ChemiStation) PPS-2510 manufactured by TOKYO RIKAKIKAI CO., LTD., and 4.8 g of methanol was added. The test tube was capped and sealed. These were heated at 64° C. at atmospheric pressure for 6 hours for esterification. The yield of methyl oleate was 99.5%.

Then, the above catalyst was placed in a beaker, together with 10 ml of methanol at room temperature, and washing was performed for 10 minutes while they were stirred by hand, followed by standing still to remove the methanol. The catalyst was dried at a temperature of 100° C. for 1 hour and reused. The yield of oleic acid methyl ester was 84.3%. Methanol washing was performed in a similar manner, and a total of five esterification reactions were performed. The yield is shown in Table 3.

With the methanol washing, the activity of the esterification reaction decreased.

### Example 2-3

After the esterification reactions in Comparative Example 2-2, the used catalyst was placed in a beaker, together with 10 ml of water at room temperature, and washing was performed for 10 minutes while they were stirred by hand, followed by standing still to remove the water. The catalyst was dried at a temperature of 100° C. for 1 hour and reused. The yield of oleic acid methyl ester was 91.3%. The yield is shown in Table 9. The activity of the esterification recovered more by water washing than by methanol washing.

TABLE 9

| Number | Amount of | Oleic acid | Methanol | Reaction | Yield | |
|---|---|---|---|---|---|---|
| of times | catalyst (g) | (g) | (g) | time (H) | (%) | Washing |
| 1 | 0.3 | 4.26 | 4.8 | 6 H | 99.5 | — |
| 2 | 0.6 | 4.26 | 4.8 | 6 H | 84.3 | Methanol washing |
| 3 | 0.6 | 4.26 | 4.8 | 6 H | 75.1 | Methanol washing |
| 4 | 0.6 | 4.26 | 4.8 | 6 H | 75.7 | Methanol washing |
| 5 | 0.6 | 4.26 | 4.8 | 6 H | 80.2 | Methanol washing |
| 6 | 0.6 | 4.26 | 4.8 | 6 H | 72.8 | Methanol washing |
| 7 | 0.25 | 1.77 | 2.0 | 6 H | 91.3 | Water washing |

### Comparative Example 2-4

4.26 g of oleic acid and 0.3 g of the sulfonic acid group-introduced amorphous carbon (I) prepared in Production Example 1 were weighed into the same pressurized glass test tube as in Example 2-1, and 1.45 g of methanol was added. The test tube was capped and sealed. These were heated at 64° C. at atmospheric pressure for 6 hours for esterification. The yield of methyl oleate was 69.4%. With the methanol/fatty acid molar ratio=3, the esterification reaction is not sufficient.

### Example 2-4

1.775 g of oleic acid and 0.307 g of the sulfonic acid group-introduced amorphous carbon (II) prepared in Production Example 2 were weighed into the pressurized glass test tube of the Personal Organic Synthesizer (ChemiStation) PPS-2510 manufactured by TOKYO RIKAKIKAI CO., LTD., and 5.21 g of methanol was added. The test tube was capped and sealed. These were heated at 95° C. for 4 hours, while the pressure was kept as it is (at about 150 kPa gauge), for esterification. The yield of methyl oleate was 99.9%.

Then, the above catalyst was placed in a beaker, together with 10 ml of water at room temperature, and washing was performed for 10 minutes while they were stirred by hand, followed by standing still to remove the water. The catalyst was dried at a temperature of 130° C. for 3 hours and reused. The yield of oleic acid methyl ester was 99.8%. Water washing was performed in a similar manner, and a total of three esterification reactions were performed. The yield is shown in Table 10. With the water washing, the high activity of the esterification reaction was maintained.

TABLE 10

| Number | Amount of | Oleic acid | Methanol | Reaction | Yield | |
|---|---|---|---|---|---|---|
| of times | catalyst (g) | (g) | (g) | time (H) | (%) | Washing |
| 1 | 0.31 | 1.78 | 5.2 | 4 H | 99.9 | — |
| 2 | 0.26 | 1.49 | 4.9 | 4 H | 99.8 | Water washing |
| 3 | 0.22 | 1.27 | 4.6 | 4 H | 99.6 | Water washing |
| 4 | 0.19 | 1.07 | 4.4 | 4 H | 99.6 | Water washing |

### Example 2-5

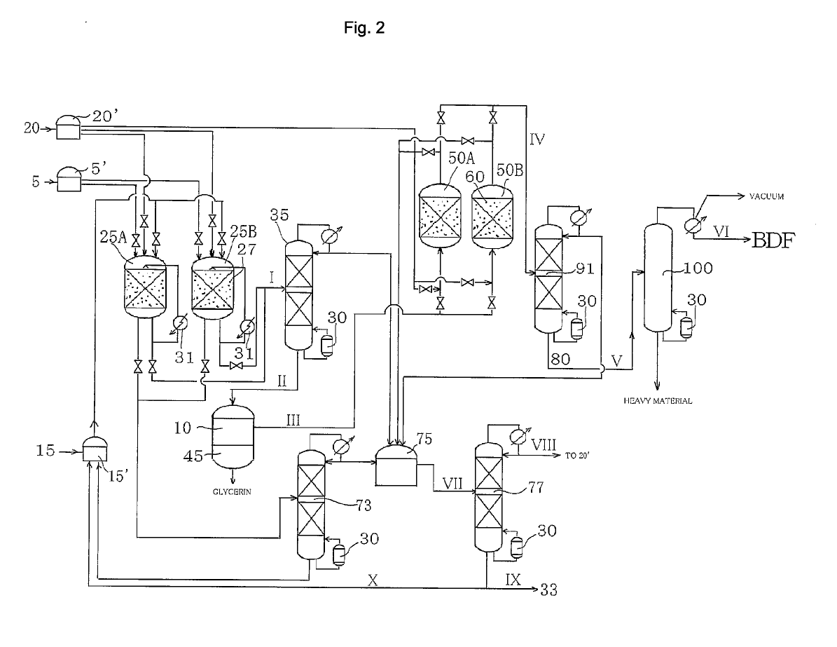

A fatty acid monoester product was produced using an apparatus shown in FIG. 2.

A fixed bed was made with 522 kg of the catalyst in Production Example 2 in a transesterification reactor A (25A) and a transesterification reactor B (25B) having a volume of 9 m³.

The transesterification reactor A was charged with 1395 kg of methanol, 3853 kg of a triglyceride, and 79 kg of water, and they were reacted at a temperature of 130° C. at a gauge pressure of 800 kPa for 5 hours. In order to promote the reaction, circulation line equipment having a heat exchanger was provided from the bottom of the transesterification reactor A toward the top for circulation, and stirring and temperature control were performed. After the completion of the reaction, the reaction product was delivered to a reactor receiving vessel. Then, water was flowed into the transesterification reactor A at 15000 kg/h for 20 minutes, and the washing liquid was circulated using external circulation piping to wash the catalyst in the transesterification reactor A. The washing liquid was discharged from the transesterification reactor A and introduced into a water-alcohol separation column (73). Methanol was distilled from the column top, temporarily stored in an alcohol storage vessel (75), and then purified in an alcohol redistillation column (77). Methanol distilled from the column top of the alcohol redistillation column (77) was circulated to an alcohol storage vessel (20′). The column bottom liquid in the water-alcohol separation column (73) was water, and the water was circulated to a water storage vessel (15′).

On the other hand, while the catalyst was washed after the completion of the reaction in the transesterification reactor A, the transesterification reactor B (25B) was charged with the same amount of methanol, the triglyceride, and water as in the transesterification reactor A, and they were reacted under the same reaction conditions as in the transesterification reactor A. When the reaction in the transesterification reactor B was completed, the catalyst in the transesterification reactor B was washed, and the transesterification reactor B and the transesterification reactor A were alternately switched between the transesterification reaction and the catalyst washing and used.

The reaction liquids in the transesterification reactor A (25A) and the transesterification reactor B (25B) were introduced into a fatty acid monoester fraction separation distillation column (35). Methanol and water were distilled from the column top and introduced into the alcohol storage vessel (75). The column bottom liquid was introduced into a glycerin separation vessel (45). In the glycerin separation vessel (45), the liquid separated into two layers, a lower layer comprising glycerin as the main component, and an upper layer of a fatty acid monoester fraction liquid (10) comprising a fatty acid ester product as the main component. The glycerin of the lower layer was discharged out of the system, and the upper layer was introduced into an esterification reactor A and an esterification reactor B disposed in parallel.

The esterification reactors A and B each had a volume of 503 L. 350 L of a cation exchange resin (manufactured by ORGANO CORPORATION, the trade name “ORGANO AMBERLYST 15JS-HG/dry”) was used as an esterification catalyst to form a fixed bed in each of the esterification reactors. Methanol was supplied into this esterification reactor A (50A) or B (50B) at 164 kg/h, and the product was introduced from the reactor upper portion to a distillation column (91). The esterification reactors A and B were switched and used as in the transesterification reaction.

Methanol and water were distilled from the column top of the distillation column (91), and the column bottom liquid was again introduced into a distillation column (100) and purified. A diesel fuel was obtained from the column top. A heavy material having a high boiling point was obtained from the column bottom.

The liquid compositions in steps I to X in FIG. 2 are shown in Table 11 and Table 12.

TABLE 11

| | I | II | III | IV | V |
|---|---|---|---|---|---|
| TG | | | | | |
| DG | 12 | 12 | 12 | 12 | 12 |
| MG | | | | | |
| Glycerin | 65 | 65 | | | |
| Fatty acid | 55 | 55 | 55 | 3 | 3 |
| Fatty acid | 577 | 577 | 577 | 632 | 632 |
| monoester | | | | | |
| product | | | | | |
| Methanol | 154 | | | 11 | |
| Water | 40 | | | 3 | |

TABLE 12

| | VI | VII | VIII | IX | X |
|---|---|---|---|---|---|
| TG | | | | | |
| DG | 0 | | | | |
| MG | | | | | |
| Glycerin | | | | | |
| Fatty acid | 2 | | | | |
| Fatty acid | 612 | | | | |
| monoester product | | | | | |
| Methanol | | 205 | 205 | | |
| Water | | 45 | 0 | 5 | 40 |

### INDUSTRIAL APPLICABILITY

According to the present invention, a fatty acid monoester product having a low acid value and a low total glycerin equivalent amount can be produced using a sulfonic acid group-introduced amorphous carbon catalyst.

Also, according to the present invention, a fatty acid monoester product having a low acid value can be continuously produced using a regenerated sulfonic acid group-introduced amorphous carbon catalyst.

This description covers contents described in the descriptions and/or the drawings of Japanese Patent Applications (Japanese Patent Application No. 2007-286875 and Japanese Patent Application No. 2007-286876), which are the basis of the priority of this application. Also, all publications, patents, and patent applications cited herein are incorporated herein by reference.

1. A method for producing a fatty acid monoester product, comprising a first step of reacting an animal oil and/or a vegetable oil with an alcohol in the presence of a sulfonic acid group-introduced amorphous carbon catalyst and water to obtain a fatty acid monoester product reaction liquid.

2. The method for producing a fatty acid monoester product according to claim 1, comprising a second step of removing glycerin, the alcohol, and water from the fatty acid monoester product reaction liquid to obtain a fatty acid monoester fraction, and a third step of contacting and reacting the fatty acid monoester fraction with an alcohol in the presence of a solid catalyst comprising a cation exchange resin and/or a sulfonic acid group-introduced amorphous carbon catalyst, following the first step.

3. The method for producing a fatty acid monoester product according to claim 2, further comprising a fourth step of obtaining the fatty acid monoester product from an esterification reaction liquid obtained in the third step.

4. The method for producing a fatty acid monoester product according to claim 2 or 3, wherein the cation exchange resin is a strongly acidic cation exchange resin.

5. The method for producing a fatty acid monoester product according to claim 1, wherein the alcohol used is methanol or ethanol.

6. The method for producing a fatty acid monoester product according to claim 1, wherein the fatty acid monoester product is a diesel fuel.

7. A method for producing a fatty acid monoester product, comprising a first step of performing a transesterification reaction of an animal oil and/or a vegetable oil with an alcohol, or an esterification reaction of a fatty acid with an alcohol, in the presence of a sulfonic acid group-introduced amorphous carbon catalyst to obtain a fatty acid monoester product reaction liquid, wherein the sulfonic acid group-introduced amorphous carbon catalyst is a water-washed sulfonic acid group-introduced amorphous carbon catalyst washed with water after being used in a transesterification reaction of an animal oil and/or a vegetable oil with an alcohol, or an esterification reaction of a fatty acid with an alcohol.

8. The method for producing a fatty acid monoester product according to claim 7, comprising a second step of removing glycerin, the alcohol, and water from the fatty acid monoester product reaction liquid to obtain a fatty acid monoester fraction, and a third step of contacting and reacting the fatty acid monoester fraction with an alcohol in the presence of a cation exchange resin and/or a sulfonic acid group-introduced amorphous carbon catalyst to obtain an esterification reaction liquid, following the first step.

9. The method for producing a fatty acid monoester product according to claim 8, further comprising a fourth step of obtaining the fatty acid monoester product from the esterification reaction liquid obtained in the third step.

10. The method for producing a fatty acid monoester product according to any of claims 7 to 9, wherein the fatty acid monoester product is a diesel fuel.
